(19) United States
(12) Patent Application Publication
(10) Pub. No.: US 2009/0311419 A1
(43) Pub. Date: Dec. 17, 2009

(54) METHOD AND APPARATUS FOR RESIST DEVELOPMENT

(76) Inventors: Anita Foerster, Dresden (DE); Marcel Heller, Stolpen (DE); Lars Voelkel, Dresden (DE)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 12/138,079

(22) Filed: Jun. 12, 2008

(51) Int. Cl. B05C 13/00; C09D 5/00

(52) U.S. Cl. 427/154; 118/57

(57) ABSTRACT

A method of developing a resist layer includes providing a substrate comprising an exposed resist layer formed on a surface of the substrate, applying a developer to the substrate, applying a rinsing liquid to the substrate, and rotating the substrate. By influencing a rotation-induced vibration of the substrate, an agglomeration of dissolved out resist components is suppressed. Moreover, an apparatus for developing a resist layer is described.

### BACKGROUND

1. Field of the Invention

The embodiments described in the following relate to a method and an apparatus for developing a resist layer.

2. Description of the Related Art

The fabrication of highly integrated electrical circuits with small structural dimensions requires special structuring procedures. A common procedure is the so-called lithographic structuring method. This method comprises applying a thin layer of a radiation-sensitive photoresist on a surface of a semiconductor substrate disc, also referred to as wafer, optionally performing a pre-baking of the resist layer, and selectively exposing the same by means of electromagnetic radiation. The electromagnetic radiation may be transmitted through or reflected by a lithographic mask in order to image lithographic structures located on the mask onto the resist layer. Instead of using a lithographic mask, selectively exposing the resist layer may also be performed by directing an electron or ion beam onto the resist layer, which is referred to as “direct writing”. A baking process may be carried out following the exposure, also referred to as “post exposure bake”.

In a development process, structuring of the exposed resist layer is performed. This process comprises applying a developing liquid to the resist layer, referred to as developer in the following, whereby a soluble portion of the resist is dissolved out and removed, respectively. Thereafter, a rinsing liquid is applied to the wafer and the wafer is rotated in order to rinse off the developer and dissolved out resist components, and to spin-dry the wafer. The wafer may also be rotated during application of the developer in order to spread the developer over the complete resist layer. The developed and thus structured resist layer may serve as a mask in subsequent process steps like for example an etching process or an ion implanting process in order to selectively remove or impact on the underlying substrate material.

One main demand of the semiconductor industry is the continuous power enhancement provided by increasingly faster integrated circuits, which is interrelated to a miniaturization of the electronic structures. With the increase in circuit density and the decrease in feature size, however, lithography induced defects are becoming more and more significant. One issue is the elimination of so-called post-development defects, also referred to as “satellite” or “blob” defects. These defects are composed of resist material or fragments which are re-deposited on the wafer surface during the development process, and therefore affect subsequent process steps.

Conventional approaches for reducing post-development defects include extending the rinsing time of the rinsing step or carrying out an additional exposure of the resist. As a consequence, the lithographic process cycle is extended. Another approach is based on the application of tensides or rinse additives for defect suppression. These additional chemicals may, however, have an unclear impact on the lithographic process and on subsequent processes.

### BRIEF DESCRIPTION OF THE DRAWINGS

FIGS. 1 and 2 show plan views of wafers having post-developments defects, according to one embodiment of the invention.

FIG. 3 shows a schematic view of an apparatus for developing a resist, according to one embodiment of the invention.

FIG. 4 shows a transparent plan view of a wafer arranged on a chuck, according to one embodiment of the invention.

FIGS. 5 to 7 show schematic views of further apparatuses for developing a resist, according to one embodiment of the invention.

FIGS. 8 and 9 show plan views of further wafers, according to one embodiment of the invention.

FIGS. 10 and 11 show details of wafer notches comprising a balance weight, according to one embodiment of the invention.

FIG. 12 shows a plan view of another wafer, according to one embodiment of the invention.

FIG. 13 shows a plan view of a wafer and details regarding rotation of the same, according to one embodiment of the invention.

FIG. 14 shows a transparent plan view of a chuck supporting a wafer, the chuck comprising a balance weight, according to one embodiment of the invention.

FIG. 15 shows a schematic side view of an apparatus comprising the wafer and the chuck of FIG. 14, according to one embodiment of the invention.

Various features of embodiments will become clear from the following description, taking in conjunction with the accompanying drawings. It is to be noted, however, that the accompanying drawings illustrate selected embodiments and are, therefore, not to be considered limiting of the scope of the invention. The present invention may admit other equally effective embodiments.

### DETAILED DESCRIPTION

The embodiments described in the following relate to a method and an apparatus for developing an exposed resist layer formed on a surface of a semiconductor wafer, wherein the formation of post-development defects may be reduced or suppressed. The embodiments are based on the experience that dissolved out resist fragments do not only re-deposit but also accumulate together on the surface of a wafer to form a post-development defect pattern, which has a specific and recognizable structure. The accumulation of resist particles is related to a vibration of the wafer during the development process. A reason for a vibration is the rotation of the wafer, which is at least carried out during the rinsing and drying part of the development process.

One embodiment includes a method of developing a resist layer, the method comprising providing a substrate comprising an exposed resist layer formed on a surface of a substrate, applying a developer to the substrate to cause development of the resist layer, applying a rinsing liquid to the substrate, and rotating the substrate. The method further comprises suppressing a rotation-induced vibration of the substrate to suppress an agglomeration of a dissolved out resist components.

Another embodiment includes a method of developing a resist layer, the method comprising providing a substrate comprising an exposed resist layer formed on a surface of the substrate, applying a developer to the substrate to cause development of the resist layer, applying a rinsing liquid to the substrate, and rotating the substrate. The method further comprises applying a time-variant excitation vibration to the substrate. The excitation vibration superposes with a rotation-induced vibration of the substrate and excites the substrate to vibrate in a time-variant manner to suppress an agglomeration of dissolved out resist components.

Another embodiment includes an apparatus for developing an exposed resist layer formed on a surface of a substrate. The apparatus comprises a process chamber and a rotatable supporting device located in the process chamber for supporting the substrate. The apparatus further comprises a device for applying a developer to the substrate and a device for applying a rinsing liquid to the substrate. The apparatus furthermore comprises a vibration device being configured to apply an auxiliary vibration to the substrate which superposes with a rotation-induced vibration of the substrate.

Another embodiment includes an apparatus for developing an exposed resist layer formed on a surface of a substrate. The apparatus comprises a process chamber and a rotatable supporting device located in the process chamber for supporting the substrate. The apparatus further comprises a device for applying a developer to the substrate, a device for applying a rinsing liquid to the substrate, and a rotation device located in the process chamber. The rotation device is coupled to the supporting device and is configured to rotate the supporting device. The apparatus furthermore comprises a damping device being configured to absorb a vibration of the rotation device, thereby suppressing a rotation-induced vibration of the substrate.

Another embodiment includes an apparatus for developing an exposed resist layer formed on a surface of a substrate. The apparatus comprises a process chamber and a rotatable supporting device located in the process chamber. The supporting device comprises a supporting surface for supporting the substrate, wherein a diameter of the supporting surface exceeds 120 mm. The apparatus further comprises a device for applying a developer to the substrate and a device for applying a rinsing liquid to the substrate.

Another embodiment includes an apparatus for developing an exposed resist layer formed on a surface of a substrate. The apparatus comprises a process chamber and a rotatable supporting device located in the process chamber for supporting the substrate. The supporting device comprises a balance weight to rotate the substrate in a manner that a rotation-symmetric distribution of mass with respect to the rotation axis is provided, thereby suppressing a rotation-induced vibration of the substrate. The apparatus furthermore comprises a device for applying a developer to the substrate and a device for applying a rinsing liquid to the substrate.

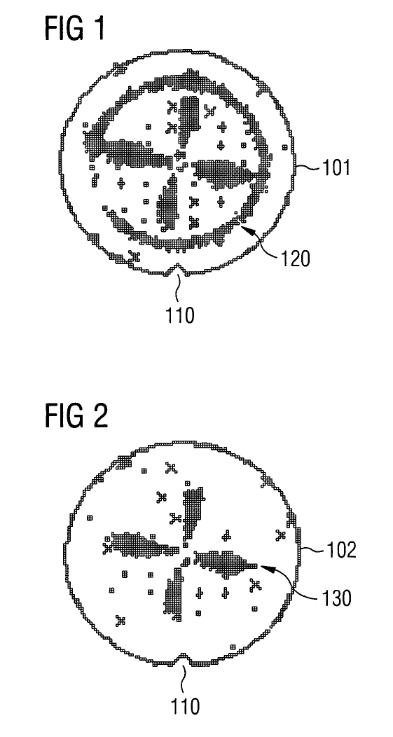

For way of illustration, FIGS. 1 and 2 show plan views of wafers 101, 102 after a development process, according to one embodiment of the invention. Defect patterns 120, 130 of accumulated resist fragments are present on the surface of the wafers 101, 102. Both the defect pattern 120 and the defect pattern 130 comprise a structure, which is comparable to a “windmill” geometry. The defect patterns 120, 130 are therefore also referred to as “windmill defects”.

The similar agglomeration of resist components in the defect patterns 120, 130 indicates a vibration of the wafers 101, 102 during the development process. This correlation makes use of the fact that the defect patterns 120, 130 have a geometric form comparable to Chladni figures. Chladni figures represent vibration modes in a mechanical surface and may for example be observed by vibrating a plate which is covered by sand. When the plate reaches resonance, the sand forms a pattern showing the nodal regions.

A further indication for a vibration-caused agglomeration of resist particles during rotation is the similar orientation of the defect patterns 120, 130 with respect to a notch 110 formed in the peripheral edge of the wafers 101, 102. The wafer notch 110, which is used for alignment purposes when processing the wafers 101, 102, may cause an unbalanced mass during rotation of the wafers 101, 102, and thus a vibration of the wafers 101, 102. In addition to this vibration fraction, a vibration of the wafers 101, 102 may for example be induced by devices applied for rotation of the wafers 101, 102.

The vibration of the wafers 101, 102 may cause a standing wave or a standing wave pattern on the wafers 101, 102, which is also present in the developing and rinsing liquid on the surface of the wafers 101, 102 during the development process. As a consequence, dissolved out resist fragments may flow to and accumulate at the nodes of the standing wave pattern, depending on the size of the particles and on the interface or surface flow of the liquid. The agglomeration of particles may further on be promoted by a charge separation caused by the movement of the particles (“diffuse double layer”), thereby lowering the activation energy for coagulation. In this connection, the aforesaid “vibration” of the wafer relates to all kinds of resonance or vibration modes which are e.g. substantially time-invariant or change in a way that an agglomeration of resist particles may take place.

The embodiments described in the following utilize the correlation between the formation of post-development defect patterns and the vibration of a wafer during rotation in a development process in order to reduce or eliminate formation of such defects. The embodiments are based on influencing or suppressing the rotation-induced vibration of the wafer in an active or passive manner.

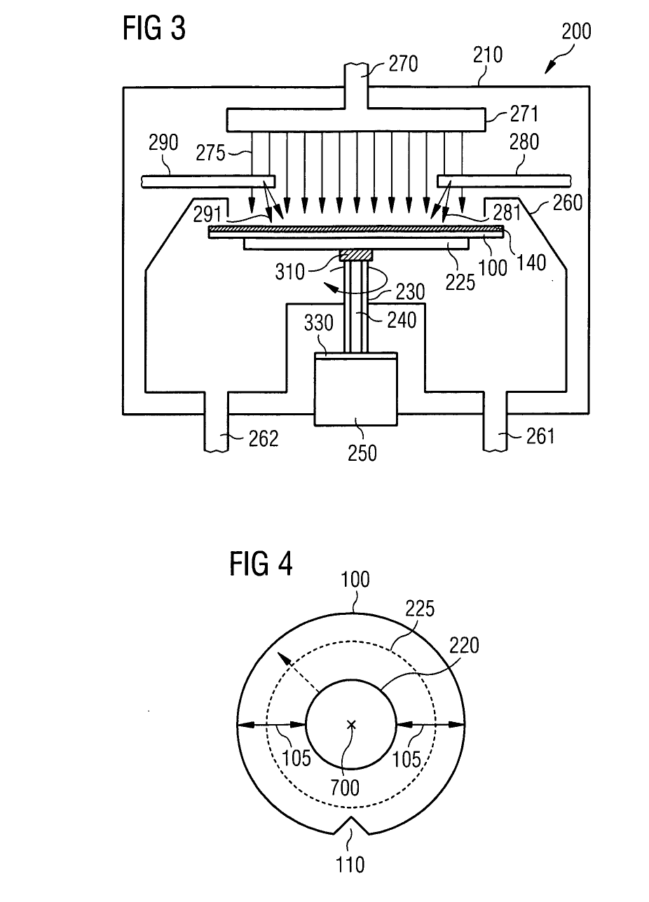

FIG. 3 shows a schematic view of an apparatus 200 for developing an exposed photoresist layer 140 which is formed on a surface of a wafer 100, according to one embodiment of the invention. The apparatus 200 comprises a process chamber 210 and a rotatable chuck 225 which is located in the process chamber 210. The wafer 100 is arranged in the process chamber 210 and on a surface of the chuck 225 which supports the wafer 100. The chuck 225 is further coupled to a spin motor 250 via a drive shaft or spindle 230 by means of which the chuck 225 and thus the wafer 100 may be rotated. The spin motor 250 may be located inside or outside of the process chamber 210.

The chuck 225 may be configured as a vacuum chuck which secures the wafer 100 on the chuck 225 by applying a vacuum or low pressure to the supporting surface of the chuck 225. For this purpose, the chuck 225 may be provided with through holes (not shown) which connect the supporting surface with a suction line 240. The suction line 240 may be arranged in the spindle 230 and may be further connected to a pumping device, for example a vacuum pump (not shown).

The apparatus 200 may further comprise a nozzle 280 for applying a developer 281 to the wafer 100 or to the resist layer 140 coating the surface of the wafer 100, respectively. The developer 281 may for example be an aqueous base solution. Various designs are conceivable for the nozzle 280 so that the developer 281 may be applied to the wafer surface in different ways, for example dispensed, dripped, sprayed etc. The nozzle 280 may further be connected to a supply line.

The apparatus 200 may further comprise a nozzle 290 for applying a rinsing liquid 291 to the wafer 100 or to the resist layer 140 arranged on the wafer surface, respectively. The rinsing liquid 291 may for example be de-ionized water. Similar to the nozzle 280, various configurations may be considered for the nozzle 290 so that the rinsing liquid 291 may be applied to the wafer surface in different ways, for example dispensed, dripped, sprayed etc. The nozzle 290 is as well further connected to a supply line.

In order to collect liquid being thrown from the wafer 100 during rotation, the apparatus 200 may comprise a cup 260. The cup 260 may comprise sidewalls which surround the wafer 100. The cup 260 may be connected to a drain 262 in order to remove collected liquid. The drain 262 may be further connected to a respective pumping device (not shown).

The apparatus 200 may furthermore comprise an inlet 270 being connected to a filter 271 and an outlet or exhaust 261 in order to create a fluid or air flow and to set a predefined atmosphere (temperature, pressure, humidity) in the process chamber 210 during a development process. The inlet 270 is further connected to a pumping device (not shown), so that a substantially uniform air flow (“laminar flow”) may be established towards the wafer surface via the filter 271, which is indicated by arrows 275. By means of the exhaust 261 which is connected to a respective pumping device (not shown), air may be evacuated from the process chamber 210. The exhaust 261 may be connected to the cup 260, as shown in FIG. 3.

In a development process, the provided wafer 100, which has been coated with the resist layer 140 and exposed to a desired pattern of electromagnetic radiation, may be arranged on the chuck 225 in the process chamber 210. The wafer 100 may be secured to the chuck 225 by applying a low pressure to the supporting surface of the chuck 225. A predetermined atmosphere and air flow may be generated inside the process chamber 210 by means of the inlet 270, the filter 271 and the exhaust 261. Developer 281 may be applied to the wafer surface by means of the nozzle 280. In this way development of the resist layer 140 takes place, i.e. that developer soluble areas of the resist layer 140 are dissolved in the developer 281.

During application of the developer 281 to the wafer surface, the chuck 225 and thus the wafer 100 may be rotated in order to spread the developer 281 over the wafer surface and the resist layer 140, respectively, and to create a pool or puddle of the developer 281 on the surface. The puddle of developer 281 is allowed to remain on the wafer surface for a time sufficient to allow a complete development and thus structuring of the resist layer 140. For this purpose, the wafer 100 may further on be rotated. Alternatively, rotation of the wafer 100 may also be stopped and the wafer 100 may be left for a predetermined time, thereby developing the resist layer 140. This information is only considered to exemplify application of the developer 281 and development of the resist layer 140, and is therefore not limiting.

Subsequently, rinsing liquid 291 may be applied to the wafer surface by means of the nozzle 290, and the wafer 100 may be rotated in such a way (e.g. by increasing the rotation speed or by applying a high(er) rotation speed) that developer 280 and dissolved out resist components may be thrown off and removed from the wafer 100. After a pre-determined time, application of the rinsing liquid 291 to the wafer 100 may be terminated, and the wafer 100 may further on be rotated in order to be spin-dried.

The apparatus 200 makes it possible to suppress a vibration of the wafer 100 during rotation and thus to suppress an agglomeration of dissolved out resist components. A rotation-induced vibration may at least be suppressed in the rinsing part of the development process. In this way the formation of post-development defects on the wafer surface may be eliminated or reduced.

For this purpose, the apparatus 200 may comprise a piezoelectric vibrator 310 which may be mechanically coupled to the wafer 100 for example via the chuck 225. As shown in FIG. 3, the piezoelectric vibrator 310 may be arranged on the rear side of the chuck 225 in the area of the spindle 230. By means of the piezoelectric vibrator 310, an auxiliary vibration may be generated and transmitted to the wafer 100 during rotation at least during the rinsing part of the development process, the auxiliary vibration superposing with a rotation-induced vibration of the wafer 100. The auxiliary vibration may be a compensation vibration which at least partially compensates the rotation-induced vibration of the wafer 100.

The compensation vibration may be for example generated with a defined frequency and amplitude. In this way, provided that the rotation-induced vibration of the wafer 100 is substantially time-invariant, the wafer vibration may be compensated for or at least partially reduced so that an agglomeration of dissolved out resist fragments is suppressed. For the case that the rotation-induced vibration of the wafer 100 has a time-variant behavior, i.e. that for example the vibration frequency and/or the amplitude change with time, the frequency and/or the amplitude of the compensation vibration may be changed in a similar way over time in order to effectively compensate for or suppress the rotation-induced vibration. A time-variant behavior of the rotation-induced vibration of the wafer 100 may for example originate from the removal of liquid from the surface of the wafer 100 during rinsing and spin-drying. In either case, application of the compensation vibration to the wafer 100 by means of the piezoelectric vibrator 310 may eliminate or reduce the formation of post-development defects.

In addition to or instead of applying a compensation vibration, the apparatus 200 may further comprise a damped bearing 330 being arranged between the spin motor 250 and the spindle 230. By means of the damped bearing 330, a vibration of the spin motor 250 when operating the same and thus the transmittance of this vibration fraction to the wafer 100 may be absorbed, thereby also suppressing a rotation-induced vibration of the wafer 100.

A further embodiment for suppressing a rotation-induced vibration of a wafer in a development process includes providing a chuck having an enlarged supporting surface. For way of illustration, FIG. 4 shows a transparent plan view of a wafer 100 having a notch 110 formed in the peripheral edge, the wafer 100 being arranged on a conventional chuck 220, according to one embodiment of the invention. The substantially circular wafer 100 may comprise a diameter of for example 300 mm. The conventional chuck 220 may comprise a circular supporting surface which has a diameter of 120 mm. FIG. 4 also indicates a center point 700 of a circle which may be defined by the substantially circular shape of the wafer 100, which corresponds to the center point of the supporting surface of the chuck 220 and to the rotation axis when rotating the chuck 220 and the wafer 100.

The arrangement of the wafer 100 on the chuck 220 may result in a relatively large overhanging portion 105 of the wafer 100 in the form of an annulus which is not supported by the supporting surface of the chuck 220. The overhanging portion 105 for example may have a width of 90 mm, which is the case for the above-identified diameter values of the wafer 100 and of the chuck 220. The unsupported overhanging portion 105 may be another cause for a rotation-induced vibration of the wafer 100, or for an intensification of the same. In the latter case, the vibration may for example be primarily induced by an unbalance due to the wafer notch 110, or caused by a vibrating spin motor 250.

Accordingly, providing a chuck with a supporting surface exceeding the supporting surface of the chuck 220 (diameter 120 mm), indicated in FIG. 4 by means of the dashed arrow, may also result in suppressing or reducing the vibration of the wafer 100 during rotation, and thus in suppressing an agglomeration of resist particles. As an example, the chuck 225 of the apparatus 200 of FIG. 3, which is indicated in FIG. 4 by means of the dashed circle, may comprise a diameter of e.g. 250 mm. Instead of providing a chuck with a supporting surface having a diameter smaller than that of the wafer 100, a chuck may also be provided with a supporting surface, the diameter of the supporting surface being equal to or exceeding the diameter of the wafer 100.

The following FIGS. 5, 6, 7 show schematic views of further apparatuses 201, 202, 203 for developing a resist layer 140 formed on a surface of a wafer 100, according to embodiments of the invention. The configuration of the apparatuses 201, 202, 203 substantially corresponds to the configuration of the apparatus 200 of FIG. 3. For a specification regarding identical components, which are denoted with the same reference numerals in FIGS. 5, 6, 7, reference is made to the preceding description. This also applies to details regarding the development process. The apparatuses 201, 202, 203 may comprise—instead of a piezoelectric vibrator 310—alternative means for applying an auxiliary vibration to the wafer 100 during rotation (at least in the rinsing part of the development process).

The apparatus 201 depicted in FIG. 5 comprises a sound wave generator 320, according to one embodiment of the invention. By means of the sound wave generator 320, a sound wave or sound wave pattern may be generated and directed to the wafer 100, thereby inducing an auxiliary vibration in the wafer 100 which superposes with a rotation-induced vibration of the wafer 100. As an example, the sound wave may be a supersonic wave. The sound wave generator 320 may be located in the process chamber 210 above the chuck 225 or wafer 100, respectively, as shown in FIG. 5. Comparable to the piezoelectric vibrator 310 of the apparatus 200 of FIG. 3, the auxiliary vibration generated by the sound wave generator 320 may be a defined or alternatively a time-variant compensation vibration which at least partially compensates the rotation-induced vibration of the wafer 100, thereby suppressing an agglomeration of resist fragments.

The apparatus 201 as well may comprise a damped bearing 330 between the spin motor 250 and the spindle 230. Additionally, a damped mounting 340 may be provided in order to attach the spin motor 250 in a damped manner. The damped mounting 340 may also serve for absorbing a vibration originating from the spin motor 250 and thus for suppressing a transmittance of the same to the wafer 100. In one embodiment, instead of providing both the damped bearing 330 and the damped mounting 340, only one of these damping elements 330, 340 may be used for absorbing a vibration of the spin motor 250.

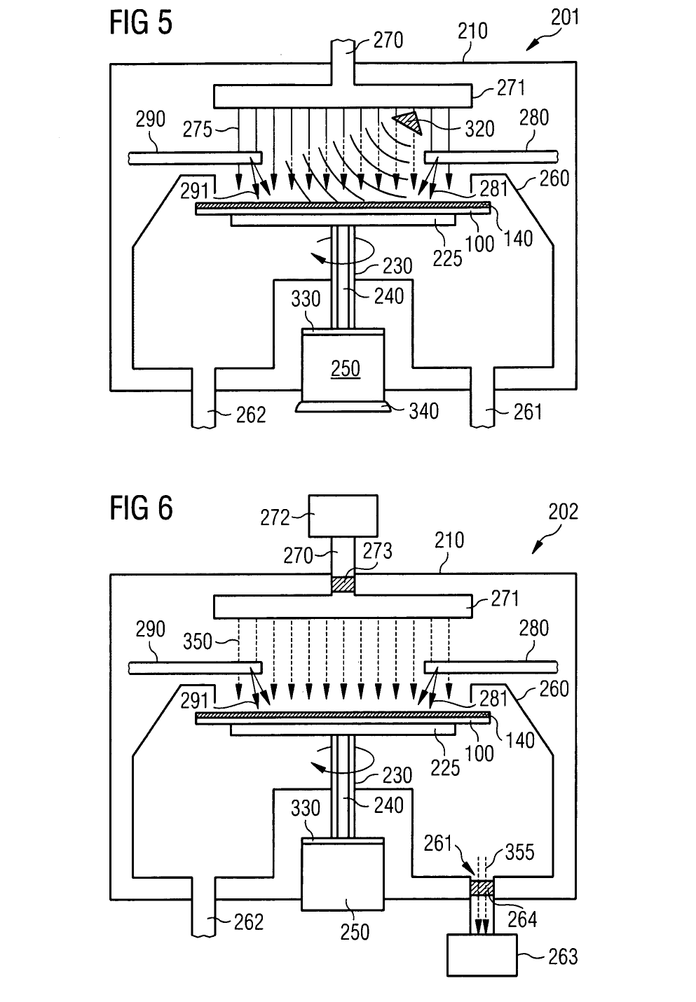

The apparatus 202 shown in FIG. 6 is configured to vary the air flow introduced to and/or exhausted from the process chamber 210 for generating an auxiliary vibration which superposes with a rotation-induced vibration of the wafer 100, according to one embodiment of the invention. In this way a pressure oscillation may be generated in the process chamber 210, which impacts on the wafer 100. By means of the auxiliary vibration, again the rotation-induced vibration of the wafer 100 may be at least partially compensated to suppress an agglomeration of resist components.

A varying air flow introduced to the process chamber 210 via the inlet 270 and the filter 271 is indicated by the dashed arrows 350 in FIG. 6. FIG. 6 furthermore depicts a pumping device 272 being connected to the inlet 270, by means of which air may be supplied to the inlet 270 and thus to the process chamber 210. Here, the pumping device 272 may be configured to supply air in an oscillating manner, e.g. by varying the provided pressure. Alternatively, the pumping device 272 may provide a constant pressure and air flow, and an oscillation may be generated by means of an additional oscillation device 273. As shown in FIG. 6, the device 273 may be arranged in the inlet 270. The oscillation device 273, which may for example be a valve, may generate the varying air flow by e.g. periodically suspending or reducing the air flow.

An oscillating air flow exhausting from the process chamber 210 via the exhaust 261 is indicated in FIG. 6 by dashed arrows 355. FIG. 6 further depicts a pumping device 263 being connected to the exhaust 261, by means of which air may be evacuated from the process chamber 210. Similarly to the pumping device 272, the pumping device 263 may be configured to exhaust air in an oscillating manner, e.g. by varying the applied low pressure. Alternatively, the pumping device 263 may suck with a constant low pressure, and an oscillation may be generated by means of an additional oscillation device 264. The device 264 may be arranged in the exhaust 264, as indicated in FIG. 6. The oscillation device 264, which may for example be a valve, may generate the varying air flow by e.g. periodically suspending or reducing the exhausted air flow.

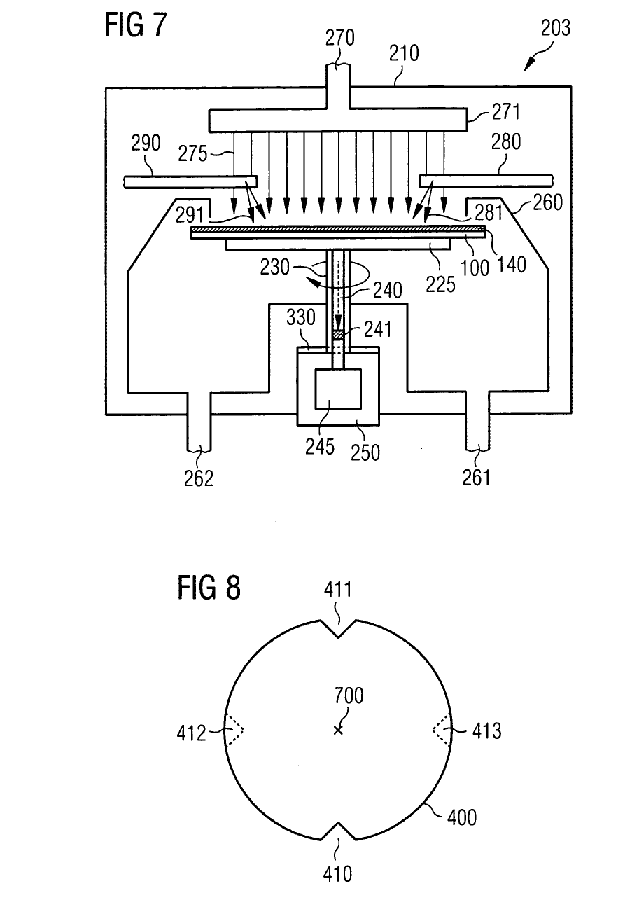

The apparatus 203 depicted in FIG. 7 utilizes the low pressure which is applied to the supporting surface of the chuck 225 for securing the wafer 100 to the supporting surface, according to one embodiment of the invention. The apparatus 203 may be configured to vary the applied low pressure in order to apply an auxiliary vibration to the wafer 100 which superposes with a rotation-induced vibration of the wafer 100. By means of the auxiliary vibration, again the rotation-induced vibration of the wafer 100 may be at least partially compensated to suppress an agglomeration of resist components.

The oscillating low pressure is indicated by a dashed arrow in the suction line 240 of the apparatus 203. FIG. 7 furthermore depicts a pumping device 245 being connected to the suction line 240. For varying the applied low pressure, the pumping device 245 may be configured to exhaust air in an oscillating manner. Alternatively, the pumping device 245 may suck with a constant pressure, and an oscillation may be generated by means of an oscillation device 241. The oscillation device 241 which may be arranged in the suction line 240 may for example be a valve.

In one embodiment, another approach for suppressing a rotation-induced vibration of a wafer in a development process is based on providing a rotation-symmetric distribution of mass with respect to the rotation axis. It is for example possible to provide a wafer having a peripheral edge, a notch being formed in the peripheral edge for alignment purposes and at least one balancing element. By means of the balancing element, an unbalance during rotation of the wafer due to the notch may at least be partially compensated to suppress the rotation—or unbalance-induced vibration.

For way of illustration, FIG. 8 shows a plan view of a wafer 400. The wafer 400 comprises a first notch 410 which is used for alignment purposes, according to one embodiment of the invention. Moreover, a second notch 411 serving as balancing element may be formed in the peripheral edge of the wafer 400 at the opposite side. As a consequence, a more symmetric distribution of mass with respect to the rotation axis may be provided compared to a wafer, for example the wafer 100 depicted in FIG. 4, having only one notch 110. Here, the wafer 400 is rotated around the center point 700 of a circle defined by the substantially circular shape of the wafer 400. The higher symmetry in mass distribution may result in a reduced unbalance and thus in a reduced vibration during rotation, thereby suppressing an agglomeration of dissolved out resist components.

As indicated in FIG. 8, the wafer 400 may be provided with two additional notches 412, 413 arranged at opposite sides of the wafer 400. In this way, the symmetry of the distribution of mass with respect to the rotation axis may be further enhanced. Instead of the wafer 400 having two or four notches 410, 411, 412, 413, the wafer 400 may also be provided with a different number of notches.

The additional notches 411, 412, 413 may have a shape differing from the shape of the first notch 410. In this way, the alignment of the wafer 400 may further on be carried out by determining the position of the first notch 410 on the wafer 400, since the notch 410 may be distinguished from the additional notches 411, 412, 413.

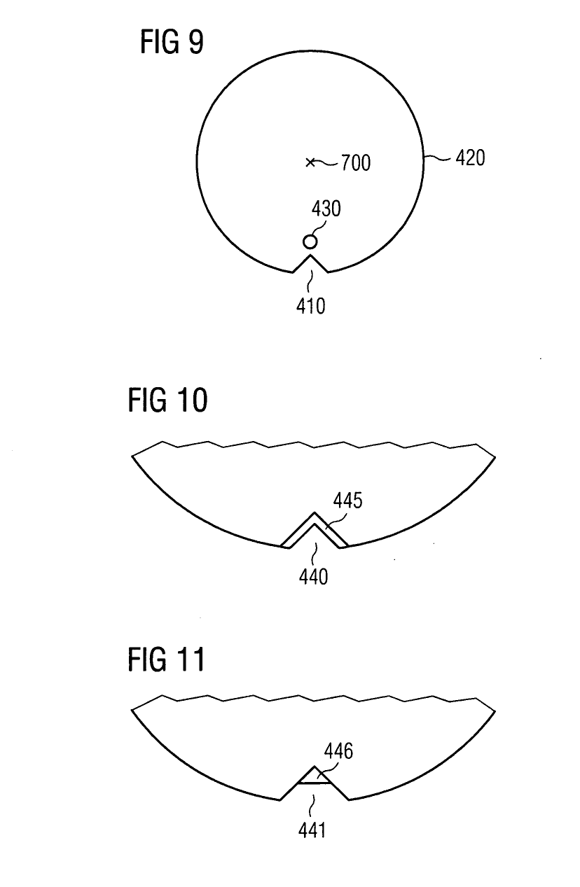

FIG. 9 shows a plan view of another wafer 420 comprising a notch 410 in the peripheral edge, according to one embodiment of the invention. Instead of an additional notch, the wafer 420 comprises a balance weight 430, which may be applied on the wafer 420 close to the notch 410. By means of the balance weight 430, an unbalance during rotation (rotation axis corresponds to center point 700) may be reduced as well. Instead of one balance weight 430, a plurality of balance weights may also be provided.

The following FIGS. 10 and 11 show configurations of potential wafer notches 440, 441 in an enlarged illustration, according to embodiments of the invention. Balance weights 445, 446 for reducing a rotation unbalance may be directly provided in the notches 440, 441 in the form of layers. In this way, the available wafer surface may not be reduced in comparison with e.g. the wafer 420 of FIG. 9. The balance weights 445, 446 may comprise a material which has a density exceeding the density of the surrounding semiconductor material of the respective wafer. As an example, the balance weights 445, 446 may comprise a metal, e.g. in the form of solder.

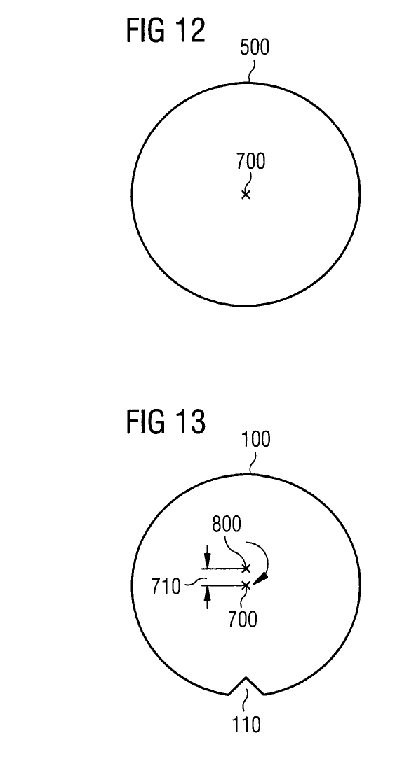

FIG. 12 shows a plan view of another wafer 500 which may be provided for a development process and being coated with an exposed resist layer (not shown), according to one embodiment of the invention. Here, the formation of a notch is omitted so that the peripheral edge of the wafer 500 has the form of a continuous circular curve. In this way, an unbalance of the wafer 500 during rotation (rotation axis corresponds to center point 700) and a thereby generated vibration may be suppressed to a high degree. Due to a missing notch, the wafer 500 may be provided with other means for alignment purposes. An example is a respective alignment structure formed on the wafer surface.

Another embodiment for providing a more rotation-symmetric distribution of mass with respect to a rotation axis is illustrated with respect to the plan view of a wafer 100 comprising a notch 110 shown in FIG. 13. Also depicted is a center point 700 of a circle defined by the substantially circular shape of the wafer 100. Instead of rotating the wafer 100 around a rotation axis corresponding to the center point 700, the wafer 100 may be rotated around a rotation axis 800 being displaced from the center point 700 by a distance 710. As a consequence, a rotation unbalance and thus a vibration during a development process may be at least partially suppressed. Such a displaced rotation of the wafer 100 may for example be realized by arranging the wafer 100 in a displaced manner on a chuck, e.g. on the chuck 225 of one of the apparatuses 200, 201, 202, 203 of FIGS. 3, 5, 6, 7.

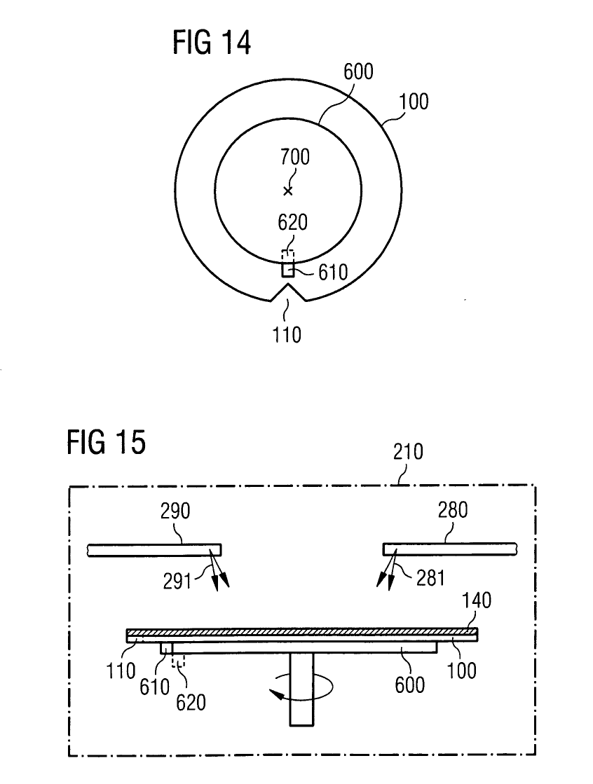

FIGS. 14 and 15 illustrate a further alternative for providing a rotation-symmetric distribution of mass with respect to a rotation axis in a development process, according to embodiments of the invention. A wafer 100 comprising a notch 110 formed in the peripheral edge and having a resist layer 140 applied on the wafer surface may be arranged on a supporting surface of a chuck 600. FIG. 15 also indicates a process chamber 210 of a respective development apparatus and nozzles 280, 290 for application of a developer 281 and of a rinsing liquid 291. The wafer 100 may be rotated around a rotation axis which corresponds to a center point 700 of a circle defined by the substantially circular shape of the wafer 100 (and of the supporting surface of the chuck 600).

In order to suppress an unbalance and thus a vibration during rotation caused by the notch 110 of the wafer 100, the total mass distribution of both the wafer 100 and the chuck 600 may be accounted for. Instead of providing a balancing element on the wafer 100, the chuck 600 may comprise an additional balance weight 610. In this way a more symmetric distribution of mass (mass of the wafer 100 plus mass of the chuck 600) with respect to the rotation axis may be provided. As illustrated in the side view of FIG. 15, the balance weight 610 may be arranged on the side edge of the chuck 600. Alternatively, the chuck 600 may be provided with a balance weight 620 which may be arranged on the rear side of the chuck 600. The chuck 600 may additionally comprise, apart from a balance weight 610, 620 for suppressing a rotation unbalance, an enlarged supporting surface.

Instead of reducing or suppressing a vibration of a wafer during rotation in an active or passive manner in a development process as described above, it is likewise possible to specifically excite the wafer to vibrate in a time-variant manner. In this way, an agglomeration of dissolved out resist components (which is based on a substantially time-invariant standing wave pattern) may be impeded and therefore also suppressed.

With respect to the apparatuses 200, 201, 202, 203 of FIGS. 3, 5, 6, 7, the generated auxiliary vibration, which may be applied to the wafer 100 at least during the rinsing part of the development process, may be used for this purpose. In this case, the auxiliary vibration—generated or induced by means of the piezoelectric vibrator 310, by applying a sound wave to the wafer 100, by varying the air flow introduced to and/or exhausted from the process chamber 210, and by varying the low pressure applied to the supporting surface of the chuck 225—may be a time-variant excitation vibration superposing with a rotation-induced vibration of the wafer 100 and causing the wafer 100 to vibrate in a time-variant manner. As an example, the frequency and/or amplitude of the excitation vibration may be changed permanently over time or in predetermined time intervals to cause such a wafer vibration. In the case of applying an excitation vibration, embodiments aiming at suppression of a vibration like e.g. provision of a damped bearing 330, a damped mounting 340, an enlarged supporting surface of a chuck, balancing elements etc. may be omitted.

The devices and methods described in conjunction with the drawings are to be considered as examples and not limiting. The different embodiments are based on influencing a vibration of a wafer in a development process. The development process includes providing a wafer being coated with an exposed resist layer, applying a developer to the wafer, applying a rinsing liquid to the wafer, and rotating the wafer. The vibration of the wafer is induced by or occurs during rotation. By influencing the wafer vibration, the embodiments make it possible to suppress an agglomeration of dissolved out resist components and thus to suppress formation of post-development defects.

Apart from the described embodiments, further embodiments may be realized which comprise further modifications and combinations of the described devices and methods. It is e.g. possible to provide the apparatuses 200, 201, 202, 203 of FIGS. 3, 5, 6, 7 with a damped mounting 340 instead of a damped bearing 330, or both with a damped bearing 330 and a damped mounting 340 for additionally absorbing a vibration of the spin motor 250. Moreover, an apparatus for development of a resist may be conceived, wherein suppressing a rotation-induced wafer vibration is carried out by means of a damping device which absorbs a vibration of a spin motor.

A potential example for a combination of different embodiments may be considered for generating an auxiliary vibration. It is e.g. possible to simultaneously use a piezoelectric vibrator and to vary the air flow introduced to and/or exhausted from a process chamber. Further combinations are for example actively generating a compensation vibration together with providing an enhanced rotation-symmetric distribution of mass with respect to a rotation axis.

Moreover, the detailed specification of the development process given with respect to the apparatus 200 of FIG. 3 is to be considered as an example and therefore not limiting. It is e.g. possible to perform an additional pre-rinsing step before application of a developer 281. Application of a developer 281 to the wafer surface may also be carried out without rotating the wafer 100, i.e. that rotation of the wafer 100 may be only performed in the rinsing and drying part of the development process.

The preceding description describes examples of embodiments of the invention. The features disclosed therein and the claims and the drawings can, therefore, be useful for realizing the invention in its various embodiments, both individually and in any combination. While the foregoing is directed to embodiments of the invention, other and further embodiments of this invention may be devised without departing from the basic scope of the invention, the scope of the present invention being determined by the claims that follow.

What is claimed is:

1. A method of developing a resist layer, comprising:
providing a substrate comprising an exposed resist layer formed on a surface of the substrate;
applying a developer to the substrate to cause development of the resist layer;
applying a rinsing liquid to the substrate;
rotating the substrate; and
suppressing a rotation-induced vibration of the substrate to suppress an agglomeration of dissolved out resist components.

2. The method according to claim 1, wherein suppressing the rotation-induced vibration of the substrate comprises applying a compensation vibration to the substrate, the compensation vibration at least partially compensating the rotation-induced vibration of the substrate.

3. The method according to claim 2, wherein applying the compensation vibration to the substrate comprises applying a sound wave to the substrate.

4. The method according to claim 2, wherein applying the compensation vibration to the substrate is carried out by means of a piezoelectric vibrator being mechanically coupled to the substrate.

5. The method according to claim 2, further comprising arranging the substrate in a process chamber, wherein applying the compensation vibration to the substrate comprises varying an air flow introduced to and/or exhausted from the process chamber.

6. The method according to claim 2, further comprising arranging the substrate on a supporting surface of a supporting device and securing the wafer to the supporting device by applying a low pressure to the supporting surface, wherein applying the compensation vibration to the substrate comprises varying the low pressure applied to the supporting surface.

7. The method according to claim 1, further comprising arranging the substrate on a supporting device, the supporting device being coupled to a rotation device for rotating the supporting device, wherein suppressing the rotation-induced vibration of the substrate comprises at least partially absorbing a vibration of the rotation device.

8. The method according to claim 1, further comprising arranging the substrate on a supporting surface of a supporting device, wherein a diameter of the supporting surface exceeds 120 mm to suppress the rotation-induced vibration of the substrate.

9. The method according to claim 1, wherein the substrate is provided comprising a peripheral edge, the peripheral edge having the form of a continuous circular curve to suppress the rotation-induced vibration of the substrate.

10. The method according to claim 1, wherein the substrate provided comprises a peripheral edge, a notch being formed in the peripheral edge, and at least one balancing element which at least partially compensates an unbalance during rotation of the substrate to suppress the rotation-induced vibration of the substrate.

11. The method according to claim 10, wherein the at least one balancing element comprises one of:
a balance weight applied on the substrate; and
a further notch being formed in the peripheral edge.

12. The method according to claim 1, wherein the substrate is rotated in a manner that a rotation-symmetric distribution of mass with respect to a rotation axis is provided to suppress the rotation-induced vibration of the substrate.

13. A method of developing a resist layer, comprising:
providing a substrate comprising an exposed resist layer formed on a surface of the substrate;
applying a developer to the substrate to cause development of the resist layer;
applying a rinsing liquid to the substrate;
rotating the substrate; and
applying a time-variant excitation vibration to the substrate, the excitation vibration superposing with a rotation-induced vibration of the substrate and exciting the substrate to vibrate in a time-variant manner to suppress an agglomeration of dissolved out resist components.

14. The method according to claim 13, wherein applying the excitation vibration to the substrate comprises applying a sound wave to the substrate.

15. The method according to claim 13, wherein applying the excitation vibration to the substrate is carried out by means of a piezoelectric vibrator being mechanically coupled to the substrate.

16. The method according to claim 13, further comprising arranging the substrate in a process chamber, wherein applying the excitation vibration to the substrate comprises varying an air flow introduced to and/or exhausted from the process chamber.

17. The method according to claim 13, further comprising arranging the substrate on a supporting surface of a supporting device and securing the wafer to the supporting device by applying a low pressure to the supporting surface, wherein applying the excitation vibration to the substrate comprises varying the low pressure applied to the supporting surface.

18. An apparatus for developing an exposed resist layer formed on a surface of a substrate, comprising:
a process chamber;
a rotatable supporting device located in the process chamber for supporting the substrate;
a device for applying a developer to the substrate;
a device for applying a rinsing liquid to the substrate; and
a vibration device being configured to apply an auxiliary vibration to the substrate which superposes with a rotation-induced vibration of the substrate.

19. The apparatus according to claim 18, wherein the auxiliary vibration at least partially compensates the rotation-induced vibration of the substrate.

20. The apparatus according to claim 18, wherein the auxiliary vibration excites the substrate to vibrate in a time-variant manner.

21. The apparatus according to claim 18, wherein the vibration device comprises a sound wave generator.

22. The apparatus according to claim 18, wherein the vibration device comprises a piezoelectric vibrator being mechanically coupled to the substrate.

23. The apparatus according to claim 18, wherein the vibration device comprises an inlet device for introducing air into the process chamber and/or an outlet device for exhausting air from the process chamber, wherein the inlet device and/or the outlet device are configured to vary an air flow introduced to and/or exhausted from the process chamber to generate the auxiliary vibration.

24. The apparatus according to claim 18, wherein the vibration device is configured to apply a varying low pressure to a supporting surface of the supporting device to generate the auxiliary vibration.

25. An apparatus for developing an exposed resist layer formed on a surface of a substrate, comprising:
a process chamber;
a rotatable supporting device located in the process chamber for supporting the substrate;
a device for applying a developer to the substrate;
a device for applying a rinsing liquid to the substrate;
a rotation device located in the process chamber, the rotation device being coupled to the supporting device and being configured to rotate the supporting device; and
a damping device being configured to absorb a vibration of the rotation device, thereby suppressing a rotation-induced vibration of the substrate.

26. The apparatus according to claim 25, wherein the damping device comprises one of:
a damped bearing arranged between the supporting device and the rotation device; and
a damped mounting for attaching the rotation device in a damped manner.

27. An apparatus for developing an exposed resist layer formed on a surface of a substrate, comprising:
a process chamber;
a rotatable supporting device located in the process chamber, the supporting device comprising a supporting surface for supporting the substrate, wherein a diameter of the supporting surface exceeds 120 mm;
a device for applying a developer to the substrate; and
a device for applying a rinsing liquid to the substrate.

28. An apparatus for developing an exposed resist layer formed on a surface of a substrate, comprising:
a process chamber;
a rotatable supporting device located in the process chamber for supporting the substrate, the supporting device comprising a balance weight to rotate the substrate in a manner that a rotation-symmetric distribution of mass with respect to a rotation axis is provided, thereby suppressing a rotation-induced vibration of the substrate;
a device for applying a developer to the substrate; and
a device for applying a rinsing liquid to the substrate.
